(19) United States
(12) Patent Application Publication
(10) Pub. No.: US 2003/0212550 A1
(43) Pub. Date: Nov. 13, 2003

(54) Method, apparatus, and system for improving speech quality of voice-over-packets (VOP) systems

(76) Inventor: Anil W. Ubale, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/143,075

(22) Filed: May 10, 2002

(51) Int. Cl. G10L 11/06

(52) U.S. Cl. 704/215

(57) ABSTRACT

According to one embodiment of the invention, an apparatus is provided which includes an encoder to encode input speech signals. The speech signals contain frames of talk spurts and silence gaps. The apparatus further includes a voice activity detector coupled to the encoder, the voice activity detector to detect whether a current frame of the input speech signals is the first active frame of a talk spurt. In response to the voice activity detector detecting that the current frame is the first active frame of a talk spurt, the encoder is reset and the encoder states are initialized.

### FIELD

An embodiment of the invention relates to the field of signal processing and communications, and more specifically, relates to a method, apparatus, and system for improving speech quality of voice-over-packets (VoP) systems.

### BACKGROUND

In the past few years, communication systems and services have continued to advance rapidly in light of several technological advances and improvements with respect to telecommunication networks and protocols, in particular packet-switched networks such as the Internet. A considerable interest has been focused on Voice-over-Packet systems. Generally, Voice-over-Packet (VoP) systems, also known as Voice-over-Internet-Protocol (VoIP) systems, include several processing components that operate to convert a voice signal into a stream of packets that are sent over a packet-switched network such as the Internet and convert the packets received at the destination back to voice signal. In general, these VoP systems utilize the available bandwidth resources of a communication network efficiently through statistical multiplexing, and therefore offer considerable cost savings and other functionality advantages. It is well known that in a typical two-way conversation there is less than 50% speech activity. The rest of the speech waveform includes pauses or silence. In other words, a speech waveform includes talk-spurts and silence gaps, which are also known as on-off patterns. This fact can be exploited to conserve bandwidth required for speech transmission. For example, silence gaps or pauses can be suppressed to allow for better bandwidth utilization. Typically, the transmitter side (or transmitter end) of a VOP system includes a Voice Activity Detection (VAD) component, a Discontinuous Transmission (DTX) component, and a Comfort Noise Generation (CNG) encoder. The receiver side (or the receiver end) of the VoP system typically includes a Comfort Noise Generator (CNG) decoder. The VAD component is used to detect voice activity and activates or deactivates packet transmission to conserve bandwidth (e.g., suppressing the packet transmission of silence gaps). In other words, the VAD and CNG components are used to optimize bandwidth utilization by suppressing packet transmission of silence gaps and instead sending very low bandwidth CNG information. Although this technique results in bandwidth efficiency, it also causes intermittent or discontinuous operation of the speech encoder and decoder modules because these modules are temporarily suspended during silence gaps. In other words, the speech encoder and decoder are only invoked during talk spurts or active speech. Therefore the states (e.g., internal variables) of the speech encoder and decoder are carried over from the last active speech frame of a talk spurt to the first active speech frame of the next talk spurt. The VAD can occasionally declare offset and onset of speech as silence. Depending on the speech input, the states of active speech frame N (from one talk spurt) may be unsuitable for encoding of the active speech frame N+1 (of the next talk spurt). This can cause severe distortion in the speech quality in the form of clicks and overshoots, thus degrading the overall speech quality.

### BRIEF DESCRIPTION OF THE DRAWINGS

The invention may best be understood by referring to the following description and accompanying drawings that are used to illustrate embodiments of the invention. In the drawings:

FIG. 1 shows a block diagram of a system according to one embodiment of the invention;

FIG. 2 illustrates a block diagram of a VoP gateway according to one embodiment of the invention;

FIG. 3 shows a block diagram of a voice processing subsystem according to one embodiment of the invention;

FIG. 4 shows a block diagram of a VoP endpoint according to one embodiment of the invention;

FIG. 5 shows a flow diagram of a method according to one embodiment of the invention;

FIG. 6 illustrates a flow diagram of a method according to one embodiment of the invention;

FIG. 7 shows a diagram of an exemplary speech waveform to which one embodiment of the invention can be applied to improve speech quality; and

FIG. 8 shows a diagram of an exemplary waveform having clicks and/or overshoots due to discontinuous speech encoding and decoding.

### DETAILED DESCRIPTION

In the following detailed description numerous specific details are set forth. However, it is understood that embodiments of the invention may be practiced without these specific details.

In recent years, VoP technology has been increasingly used to convert voice, fax, and data traffic from circuit-switched format used in telephone and wireless cellular networks to packets that are transmitted over packet-switched networks via Internet Protocol (IP) and/or Asynchronous Transfer Mode (ATM) communication systems. VoP systems can be implemented in various ways depending on the applications. For example, a voice call can be made from a conventional telephone to another conventional telephone via the Public Switched Telephone Network (PSTN) connected to corresponding VoP gateway and packet-switched network such as the Internet. As another example, voice communication can be established between a conventional telephone and a personal computer that is equipped with a voice application via PSTN, VoP gateway, and the Internet.

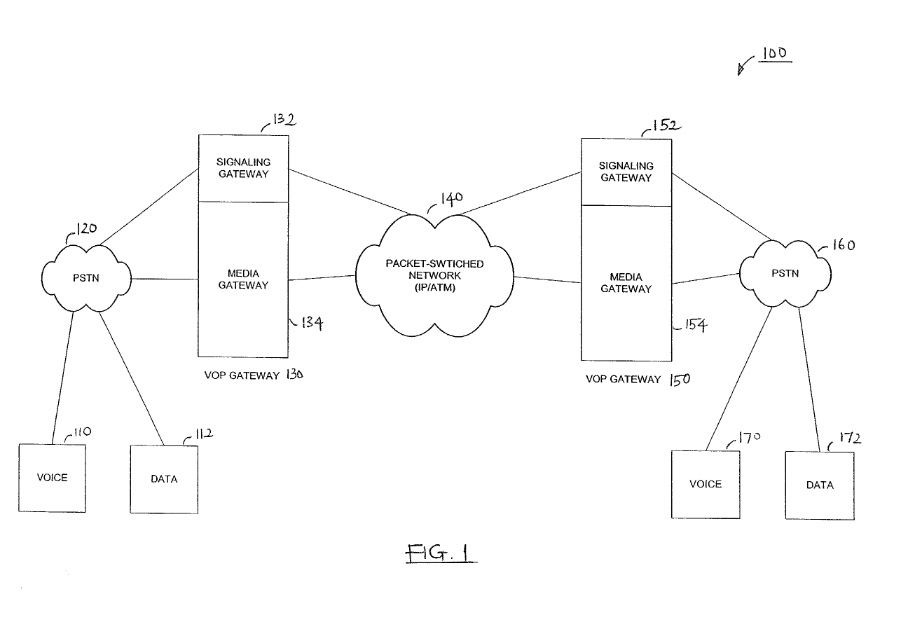

FIG. 1 illustrates a block diagram of a system 100 according to one embodiment of the invention. As shown in FIG. 1, the system 100 includes a voice communication device 110 and data communication 112 that are connected to VoP gateway system 130 via PSTN 120. In one embodiment, the VoP gateway system 130 includes corresponding signaling gateway subsystem 132 and media gateway subsystem 134 that are connected to packet-switched network (e.g., IP/ATM network) 140. The system 100 further includes voice communication device 170 and data communication device 172 that are connected to VoP gateway system 150 via PSTN 160. In one embodiment, the VoP gateway system 150 includes corresponding signaling gateway subsystem 152 and media gateway subsystem 154 that are connected to the packet-switched network 140. In one embodiment, voice communication devices 110 and 170 can be telephones or computers equipped with voice applications, or other types of devices that are capable of communicating voice signals. Data communication devices 112 and 172 can be fax machines, computers, or other types of devices that are capable of communicating data signals.

As shown in FIG. 1, a voice communication session (e.g., a voice call) can be established between voice devices 112 and 172 via the PSTN 120, the VoP gateway 130, the packet-switched network 140, the VoP gateway 150, and the PSTN 160. For example, a voice call can be initiated from the voice device 110 which converts analog voice signals to linear pulse code modulation (PCM) digital stream and transmits the PCM digital stream to the VoP gateway 130 via PSTN 120. The VoP gateway system 130 then converts the PCM digital stream to voice packets that are transmitted over the packet-switched network (e.g., the Internet) 140. At the receiving side, the VoP gateway system 150 converts received voice packets to PCM digital stream that is transmitted to the receiving device (e.g., voice device 170). The voice device 170 then converts the PCM digital stream to analog voice signals.

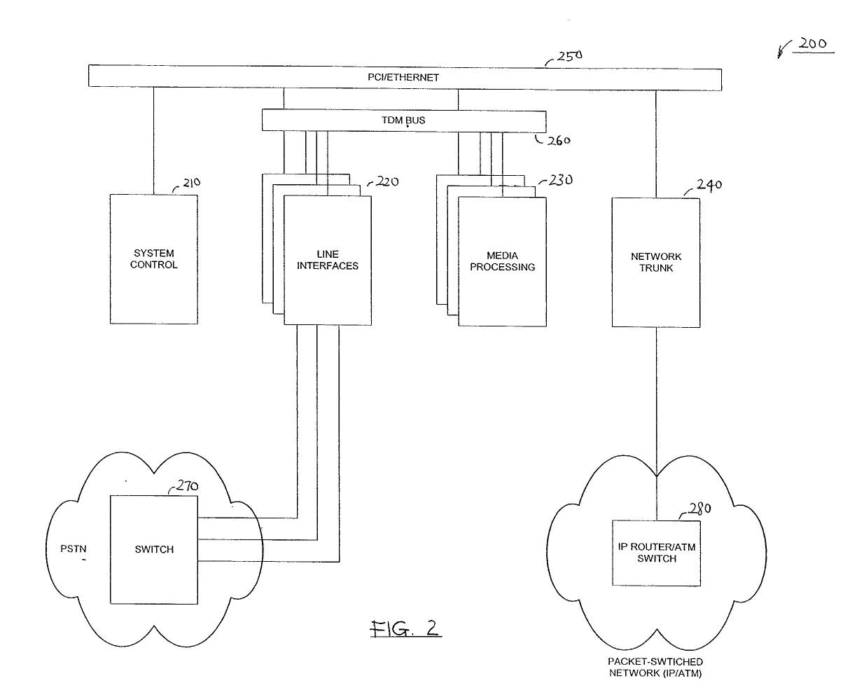

FIG. 2 illustrates a block diagram of one embodiment of an exemplary VoP gateway system 200 (e.g., the VoP gateway system 120 or 150 illustrated in FIG. 1) according to one embodiment of the invention. As shown in FIG. 2, the VoP gateway system 200, for one embodiment, includes a system control component 210 (also called system control unit system control card herein), one or more line interface components 220 (also called line interface units or line cards herein), one or more media processing components 230 (also called media processing units, media processing cards, or media processors herein), and a network trunk component 240 (also called network trunk unit or network trunk card herein). As shown in FIG. 2, the various components 210, 220, 230, and 240 are connected to each other via PCI/Ethernet bus 250. The line cards 220 and media processing cards 230 can be connected via a time-division multiplexing (TDM) bus 260 (e.g., H.110 TDM backplane bus). The line cards 220, in one embodiment, are connected to PSTN via switch 270 (e.g., a class 5 switch). The network trunk card 240 is connected to a packet-switched network (e.g., IP or ATM network) via IP router/ATM switch 280. In one embodiment, the system control card 210 is responsible for supervisory control and management of the VoP gateway system 200 including initialization and configuration of the subsystem cards, system management, performance monitoring, signaling and call control. In one embodiment, the media processing cards 230 perform the TDM to packet processing functions that involve digital signal processing (DSP) functions on voiceband traffic received from the line cards 230, packetization, packet aggregation, etc. In one embodiment, the media processing cards 230 perform voice compression/decompression (encoding/decoding), echo cancellation, DTMF and tones processing, silence suppression (VAD/CNG), packetization and aggregation, jitter buffer management and packet loss recovery, etc.

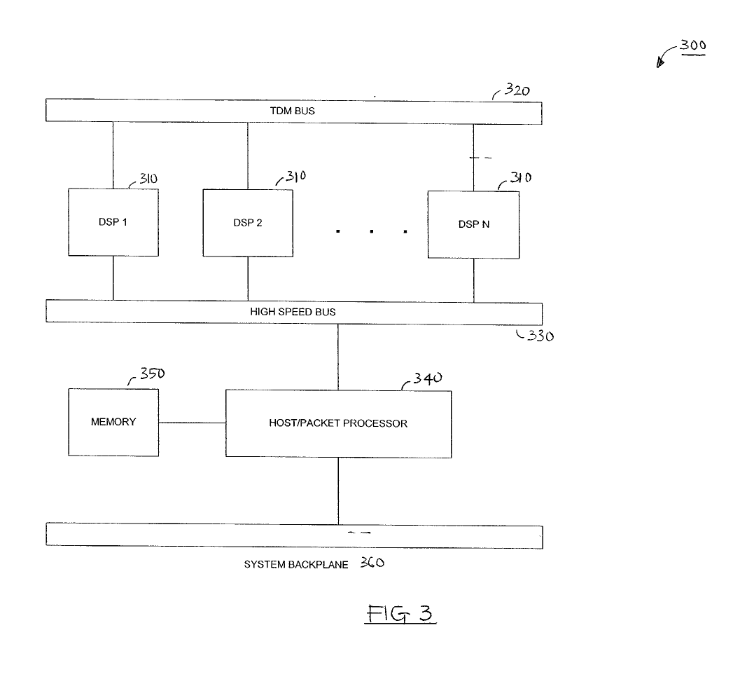

FIG. 3 illustrates a block diagram of one embodiment of an exemplary media processing component or subsystem 300 (e.g., the media processing card 230 shown in FIG. 2). In one embodiment, the media processing subsystem 300 includes one or more digital signal processing (DSP) units 310 that are coupled to a TDM bus 320 and a high-speed parallel bus 330. The media processing subsystem 300 further includes a host/packet processor 340 that are coupled to a memory 350, the high-speed parallel bus 330, and system backplane 360. In one embodiment, the DSPs 310 are designed to support parallel, multi-channel signal processing tasks and include components to interface with various network devices and buses. In one embodiment, each DSP 310 includes a multi-channel TDM interface (not shown) to facilitate communications of information between the respective DSP and the TDM bus. Each DSP 310 also includes a host/packet interface (not shown) to facilitate the communication between the respective DSP and the host/packet processor 340. In one embodiment, the DSPs 310 perform various signal processing tasks for the corresponding media processing cards which may include voice compression/decompression (encoding/decoding), echo cancellation, DTMF and tones processing, silence suppression (VAD/CNG), packetization and aggregation, jitter buffer management and packet loss recovery, etc.

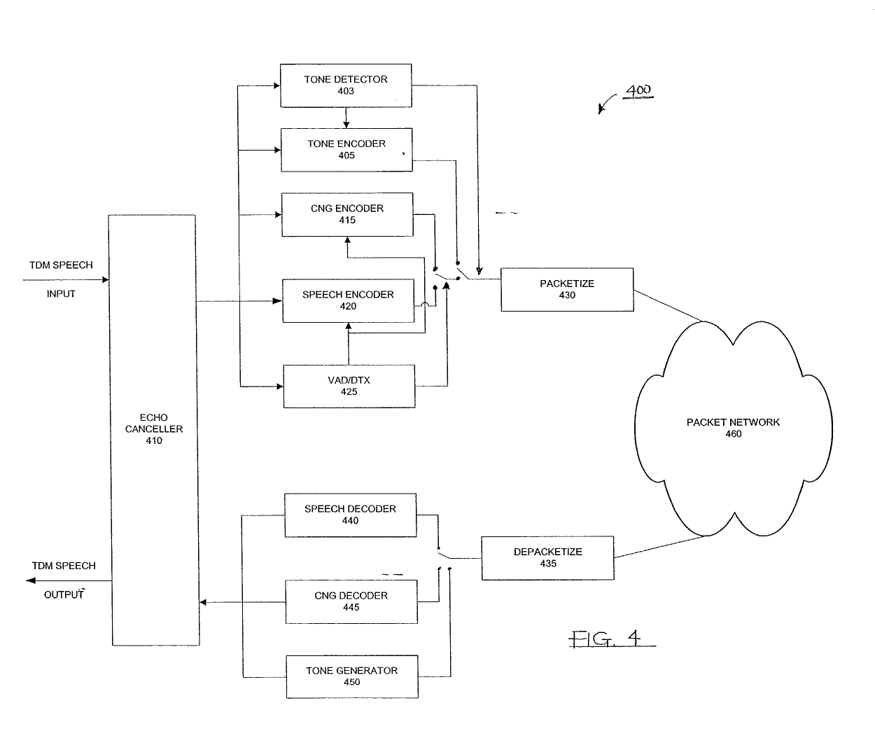

FIG. 4 shows a block diagram of an exemplary VoP endpoint 400 (also called endpoint subsystem herein) according to one embodiment of the invention. The various components or units of the VoP endpoint 400, depending upon the different hardware, software, or combinations of hardware and software implementations, or applications of the invention, may be embodied in one or more integrated circuits (ICs) and may be physically located in different subsystems or parts of a VoP system (e.g., VoP system 100). For example, the various components or units of the endpoint subsystem 400 may be implemented in a digital signal processor (DSP) (e.g., the DSP 310 illustrated in FIG. 3) that is located in a VoP gateway system or in a voice communication device such as a PC or a telephone. As shown in FIG. 4, the VoP endpoint 400 includes an echo canceller 410 coupled to receive TDM speech input and perform echo cancellation on the TDM speech input. The VoP endpoint 400 further includes a tone detector 403, a tone encoder 405, a CNG encoder 415, a speech encoder 420, and a VAD/DTX 425 that are coupled to the echo canceller 410. The VAD/DTX 425 is also coupled to communicate speech activity information (e.g., whether the input is talk-spurt or silence) to the speech encoder 420 and the CNG encoder 415. The tone encoder 405, the speech encoder 420 and the CNG encoder 415 are selectively coupled to a packetize unit 430 which is connected to packet network 460 (e.g., Internet). The endpoint 400 also includes a depacketize unit 435 selectively coupled to a speech decoder 440, a CNG decoder 445, and a tone generator 450. The speech decoder 440, the CNG decoder 445, and the tone generator 450 are coupled to the echo canceller 410.

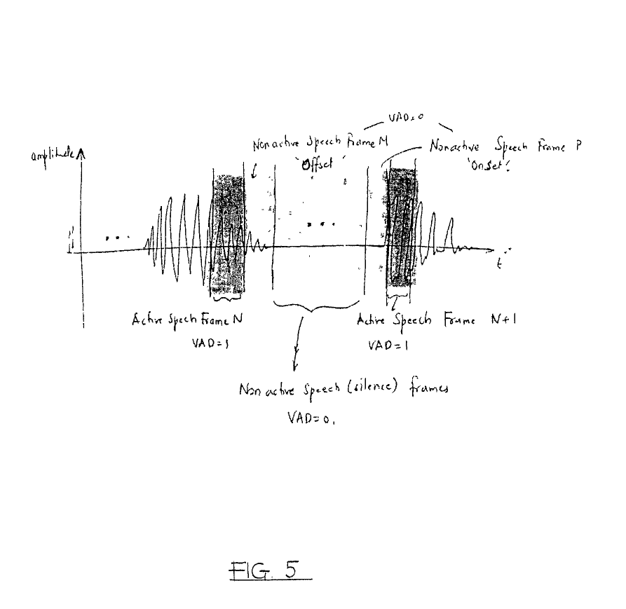

As mentioned above, a typical two-way conversation contains less than 50% speech activity. The rest of the speech waveform contains pauses or silence. In other words, a speech waveform includes talk-spurts and silences. The existence of pauses or silences can be used to optimize bandwidth utilization via silence suppression. In other words, to conserve bandwidth, input speech signal is transmitted if it is detected as active speech (talk-spurt). As shown in FIG. 4, the VAD/DTX 425 and the CNG encoder 415 operate to save bandwidth by detecting silence in the input speech signal and sending low bandwidth CNG information instead. In other words, when there is no speech activity (talk-spurts), the output from the speech encoder 420 is not transmitted to the packet network 460. As described herein, while silence suppression results in bandwidth efficiency, it also causes intermittent or discontinuous operation of the speech encoder and decoder modules because these modules are temporarily suspended during silence gaps. The discontinuous operation of speech encoder and decoder can happen in some other scenarios also, even when voice activity detection is not used. For example, many VoP systems use tone relay detection and transmission. In this case, if there are tones present in the input signal (e.g., in an interactive voice response system), the tones get detected and encoded by a tone-relay detector and encoder. During this time the speech encoder is bypassed. Similarly, at the receiver, the tones are generated using a tone generator and the speech decoder is not invoked. In other words, the speech encoder and decoder are only invoked during talk spurts or active speech. Therefore the states (e.g., internal variables) of the speech-encoder and decoder are carried over from the last active speech frame of a talk spurt to the first active speech frame of the next talk spurt. The VAD can occasionally declare offset and onset of speech as silence. As shown in FIG. 5, which illustrates an exemplary waveform of speech signals to which one embodiment of the invention can be applied, the non-active speech frame M (e.g., speech offset after active speech frame N) and the non-active speech frame P (e.g., speech onset just before active speech frame N+1) are declared by the VAD as silence (e.g., VAD=0). Depending on the speech input, the states of active speech frame N (from one talk spurt) may be unsuitable for encoding of the active speech frame N+1 (of the next talk spurt). This can cause severe distortion in the speech quality in the form of clicks and overshoots, thus degrading the overall speech quality. To resolve the speech quality problem due to silence suppression technique that is described above, one embodiment of the invention provides a mechanism to improve the speech quality while still allowing silence suppression in VoP systems to conserve bandwidth. In one embodiment, the speech encoder 420 and the speech decoder 440 are reset on the first active frame of a talk-spurt. Thus the states of the speech encoder 420 and speech decoder 410 are initialized at the start of each talk-spurt. Accordingly, the states (e.g., internal variables) of the speech encoder 420 and the speech decoder 440 are not carried over from the last active speech frame of a talk-spurt (e.g., frame N) to the first active speech frame of the next talk-spurt (frame N+1). As such, distortion in the speech quality in form of clicks and overshoots can be eliminated or greatly reduced by one embodiment of the invention.

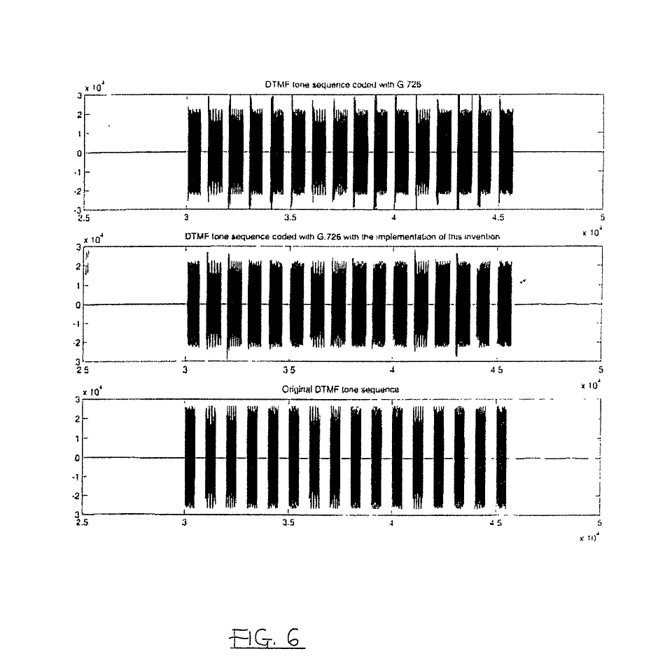

One embodiment of the invention is particularly effective for speech coders that rely on backward-adaptation, for example, G.726 ADPCM and G.728 LD-CELP. In G.726, a backward-adaptive pole-zero prediction is used. The speech codec operates at bit rates 16, 24, 32, and 40 kbps and provides good speech quality (e.g., having a Mean Opinion Score of 4.0). However, when used in Voice-over-packet systems with discontinuous speech encoding and decoding, the artifacts mentioned above appear as shown in FIG. 6 which illustrates an original DTMF tone sequence, a DTMF tone sequence coded with G.726 encoder, and a DTMF tone sequence coded with G.726 encoder with an implementation of one embodiment of the invention. In this example, for making the artifacts visible in a waveform, a DTMF tone sequence is chosen, where initial portions of the tone are encoded using G.726 encoder and later portions are detected by DTMF detector and generated at the decoder. With the implementation of one embodiment of the invention, the artifacts disappear. Similarly in G.728 LD-CELP coders a 50-th order all-zero backward-adaptive predictor is used. One embodiment of the invention can be used to improve the quality of G.728 coded speech in Voice-over-Packet systems. Other speech coders that use backward-adaptive prediction are G.727, and G.722. One embodiment of the invention can also be used to improve speech quality in VoP systems that use other speech coders such as CELP coders G.729, G.723.1, GSM-EFR, AMR, EVRC which also use backward--adaptive prediction in the form of adaptive codebook search.

Various embodiments of the invention can be utilized for improvement in the packet-loss/error performance. In Voice-over-packet systems, worst-case packet loss rates can be as high as 30%. Because the speech encoder and decoders are reset on the first active frame of a talk-spurt (the encoder and decoder states are initialized at the start of each talk-spurt), the spread of errors is contained to within a talk-spurt, assuming that the first frame of a talk-spurt and the previous frame are received without error. This is important for G.726 type of coders because after the packet loss, the encoder and decoder states usually continue to diverge until the simultaneous reset of the encoder and decoder is performed. One embodiment of the invention can be used to simultaneously reset the encoder and decoder without external side-information or indication.

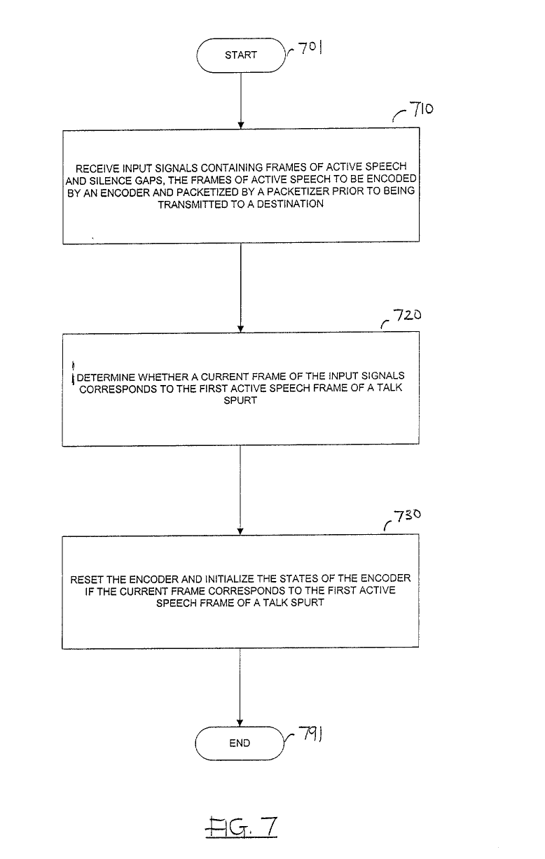

FIG. 7 shows a flow diagram of a method according to one embodiment of the invention. At block 710, input signals containing frames of active speech and silence gaps are received. In one embodiment, the input signals may also contain tones and other non-active speech frames. The frames of active speech will be encoded by an encoder and packetized by a packetizer before being transmitted to a destination over a packet-switched network. Similarly, the frames of tones will be detected and encoded by a tone detector/encoder before being transmitted. At block 720, it is determined whether a current frame of the input signals corresponds to the first active speech frame of a talk spurt. At block 730, the encoder is reset and the encoder states are initialized if the current frame corresponds to the first active speech frame of a talk spurt.

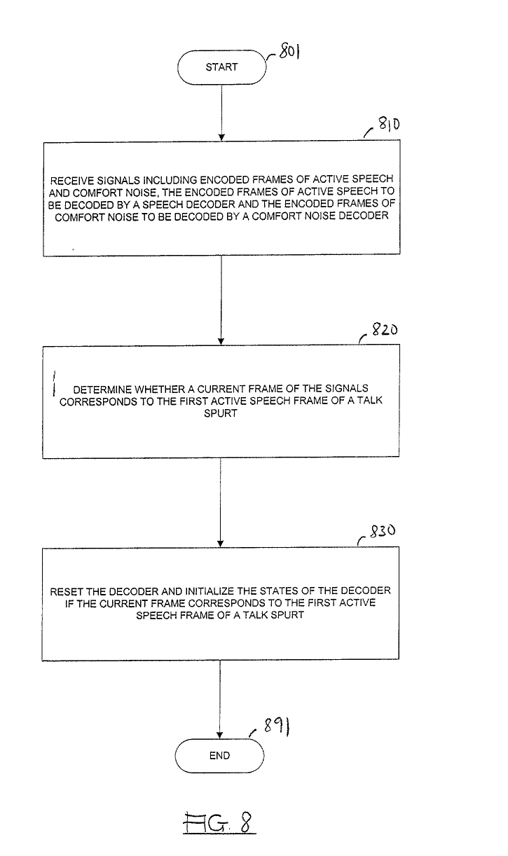

FIG. 8 shows a flow diagram of a method according to one embodiment of the invention. At block 810, signals containing encoded frames of active speech and comfort noise are received. In one embodiment, the signals received may also contain encoded tones and other non-active speech information. The encoded frames of active speech will be decoded by a speech decoder and the encoded frames of comfort noise will be decoded by a comfort noise decoder. Similarly, encoded tones will be decoded by a tone generator, etc. At block 820, it is determined whether a current frame of the signals corresponds to the first active speech frame of a talk spurt. At block 830, the decoder is reset and the decoder states are initialized if the current frame corresponds to the first active speech frame of a talk spurt.

It should be noted that various embodiments of the invention do not require that both the encoder and the decoder be reset. For example, in one embodiment of the invention, only the decoder is reset when the receiver receives a first active speech frame after a duration (e.g., a series) of tone frames is received. This embodiment is suitable in many of the forward-adaptive LP based CELP codecs such as G.723.1, G.729, G.729A, AMR, EVRC, etc.

While the invention has been described in terms of several embodiments, those of ordinary skill in the art will recognize that the invention is not limited to the embodiments described herein. It is evident that numerous alternatives, modifications, variations and uses will be apparent to those of ordinary skill in the art in light of the foregoing description.

What is claimed is:

1. An apparatus comprising:
a speech encoder to encode input signals containing talk spurts; and
a voice activity detector (VAD) coupled to the speech encoder, the voice activity detector to detect whether a current frame of the input signals is a first active frame of a talk spurt,
wherein, in response to the voice activity detector detecting that the current frame is the first active frame of a talk spurt, the speech encoder is reset and the speech encoder states are initialized.

2. The apparatus of claim 1 further including:
a comfort noise generator (CNG) coupled to the voice activity detector, the comfort noise generator to generate comfort noise in response to the voice activity detector detecting silence gaps.

3. The apparatus of claim 1 wherein, in response to the encoder being reset and the encoder states being initialized, the states of the encoder are not carried over from the last active speech frame of a talk spurt to the first active speech frame of the next talk spurt.

4. The apparatus of claim 3 wherein the encoder and the comfort noise generator are selectively coupled to a packetize unit, depending on whether the input signals contain speech activity.

5. The apparatus of claim 4 wherein the encoder is coupled to the packetize unit when the input signals contain speech activity and the comfort noise generator is coupled to the packetize unit when the input signals contain no speech activity.

6. The apparatus of claim 5 wherein the encoder and the comfort noise generator are selectively coupled to the packetize unit based on the value of a speech activity indicator signal generated by the voice activity detector.

7. The apparatus of claim 1 further including:
a speech decoder to decode encoded frames of talk spurts, wherein the speech decoder is reset and the speech decoder states are initialized on a first active frame of a talk spurt.

8. The apparatus of claim 7 further including:
a comfort noise decoder coupled to receive and decode comfort noise signals.

9. The apparatus of claim 8 wherein the decoder and the comfort noise decoder are selectively coupled to a depacketize unit.

10. The apparatus of claim 9 wherein the depacketize unit is coupled to the decoder when the received signals contain talk spurts and is coupled to the comfort noise decoder when the received signals contain comfort noise.

11. The apparatus of claim 7 wherein the speech decoder is reset and the speech decoder states are initialized on a first active frame of a talk spurt after a series of tone frames are received.

12. A method comprising:
receiving input signals including frames of active speech, the frames of active speech to be encoded by a speech encoder and packetized by a packetizer prior to being transmitted to a destination over a packet-switched network;
determining whether a current frame of the input signals corresponds to a first active speech frame of a talk spurt; and
resetting the speech encoder and initializing the speech encoder states if the current frame corresponds to the first active speech frame of a talk spurt.

13. The method of claim 12 further including:
in response to detecting silence gaps, generating comfort noise to be transmitted to the destination.

14. The method of claim 12 wherein, in response to the speech encoder being reset and the speech encoder states being initialized, the states of the speech encoder are not carried over from the last active speech frame of a talk spurt to the first active speech frame of the next talk spurt.

15. The method of claim 13 wherein encoded active speech frames and comfort noise are selectively transmitted, depending on whether the input signals contain active speech frames or silence gaps.

16. The method of claim 12 further including:
receiving signals including encoded frames of active speech, the encoded frames of active speech to be decoded by a speech decoder; and
resetting the speech decoder and initializing the speech decoder states on a first active speech frame of each talk spurt.

17. The method of claim 16 wherein the speech decoder is reset and the speech decoder states are initialized on a first active speech frame after a series of tone frames are received.

18. A system comprising:
an echo canceller coupled to receive input speech signals including frames of active speech and silence gaps, the echo canceller to perform echo cancellation on the input speech signals; and
a transmitter component including:
a speech encoder coupled to the echo canceller, the speech encoder to encode frames of active speech for transmission to a destination over a network; and
a voice activity detector (VAD) coupled to the echo canceller and the speech encoder, the VAD to detect whether active speech is present in the input frames,
wherein the speech encoder is reset and the encoder states are initialized on the first active speech frame of each talk spurt.

19. The system of claim 18 further including:
a comfort noise encoder coupled to the voice activity detector, the comfort noise encoder to generate comfort noise in response to the voice activity detector detecting silence gaps.

20. The system of claim 18 wherein, in response to the encoder being reset and the encoder states being initialized, the states of the encoder are not carried over from the last active speech frame of a talk spurt to the first active speech frame of the next talk spurt.

21. The system of claim 20 further including:
a packetize unit selectively coupled to the speech encoder and the comfort noise encoder, depending on whether the input frames contain speech activity.

22. The system of claim 21 wherein the packetize unit is coupled to the speech encoder when the input frames contain speech activity and coupled to the comfort noise encoder when the input frames contain no speech activity.

23. The system of claim 18 further including:
a speech decoder coupled to receive and decode encoded frames of talk spurts, wherein the speech decoder is reset and the speech decoder states are initialized on the first active frame of a talk spurt.

24. The system of claim 23 further including:
a comfort noise decoder coupled to receive and decode comfort noise signals.

25. The system of claim 24 wherein the speech decoder and the comfort noise decoder are selectively coupled to a depacketize unit.

26. The system of claim 23 wherein the speech decoder is reset on the first active speech frame after a series of tone frames are received.

27. A machine-readable medium comprising instructions which, when executed by a machine, cause the machine to perform operations including:
receiving input signals including frames of active speech, the frames of active speech to be encoded by a speech encoder and packetized by a packetizer prior to being transmitted to a destination over a packet-switched network;
determining whether a current frame of the input signals corresponds to a first active speech frame of a talk spurt; and
resetting the speech encoder and initializing the speech encoder states if the current frame corresponds to the first active speech frame of a talk spurt.

28. The machine-readable medium of claim 27 further including:
in response to detecting silence gaps, generating comfort noise to be transmitted to the destination.

29. The machine-readable medium of claim 27 further including:
receiving signals including encoded frames of active speech, the encoded frames of active speech to be decoded by a speech decoder; and
resetting the speech decoder and initializing the speech decoder states on a first active speech frame of each talk spurt.

30. The machine-readable medium of claim 29 wherein the speech decoder is reset and the speech decoder states are initialized on a first active speech frame after a series of tone frames are received.
